(19) United States
(12) Patent Application Publication
(10) Pub. No.: US 2003/0097392 A1
(43) Pub. Date: May 22, 2003

(54) Four-rail NCL incrementor/decrementor

(76) Inventor: Steven R. Masteller, Orlando, FL (US)

Correspondence Address: STEPTOE & JOHNSON LLP, Attn: Stuart T.F. Huang, 1330 Connecticut Avenue, NW, Washington, DC, 20036, US

(21) Appl. No.: 09/989,107

(22) Filed: Nov. 21, 2001

(51) Int. Cl. G06F 7/50

(52) U.S. Cl. 708/672

(57) ABSTRACT

A four-rail incrementor/decrementor circuit is presented. The circuit is capable of operating in an asynchronous (i.e., lacking a clock signal) environment. The basic circuit can be cascaded to build incrementor/decrementors that can handle numbers of arbitrarily large size. The circuit can also achieve a 50% power savings over two-rail versions.

### BACKGROUND OF THE INVENTION

1. Field of the Invention

The invention relates to incrementor/decrementor circuits in digital logic. More particularly, the invention relates to a digital asynchronous incremantor/decremantor implemented using four rail logic in a power-saving configuration.

2. Discussion of Background Information

Asynchronous circuits do not require a clock for synchronizing signals. One asynchronous logic paradigm (NULL CONVENTION LOGIC™) is disclosed U.S. Pat. No. 5,305,463, which is incorporated by reference herein in its entirety. Several data representations are discussed, but in one representation, a signal may assume a DATA value or a NULL value. A DATA value for example, might be a numeric zero or one, or a logic TRUE or FALSE, or another meaning not related to binary of Boolean logic representations. For example, in a path capable of carrying electrical signals, when the path is active that is, when the path is actively carrying current, this condition may represent a DATA, or ASSERTED, value. Similarly, when such a path carries not currrent, it may be said to represent a NULL value. Alternately, negative logic is possible; for example a path with no current may be said to indicate TRUE or DATA value. Examples of U.S. patents that disclose related technology are U.S. Pat. Nos. 5,305,463; 5,656,948; 5,664,211; and 6,043,674.

Digital incrementor/decrementors are used to add and subtract the number one from a given number. In this context, electrical signals represent numeric values (e.g., in binary). Incrementor/decrementor circuits have control inputs corresponding to the increment and decrement functions. When the increment function is activated, the circuit will output the input value plus one. Similarly, when the decrement function is activated, the circuit will output the input value minus one.

Incrementor/decrementor circuits typically use only a finite number of signals, they usually employ modular arithmetic. For example, a two-bit binary incrementor/decrementor can only represent the values: 0, 1, 2, and 3. If an input of 3 is incremented, the circuit will wrap the result around and output the number 0. Similarly, decrementing the value 0 will yield 3. Hence, whenever the incremented or decremented input is greater or smaller than the values allowed, the circuit will adjust the output accordingly. The circuit may account for borrow or carryover functions in this manner.

Because typical incrementor/decrementor circuits must switch several gates for each operation, they require a relatively large amount of power to perform their functions. Also, known incrementor/decrementor circuits typically consume power both when performing operations and when otherwise inactive. However, many applications (e.g., laptop computers) prefer low-power circuits to prefer battery charge. Additionally, circuits such as wireless environments do not have available space for large power supplies. Therefore, there is a need for an asynchronous incrementor/decrementor circuit that can operate with a small amount of power.

### SUMMARY OF THE INVENTION

The present invention provides a preferably four-rail incrementor/decrementor with a power-saving configuration.

According to a preferred embodiment of the invention, an incrementor/decrementor is provided. The incrementor/decrementor includes m control paths, n input paths, and n output paths, where m and n are positive integers with n greater than two. Each of the m control paths, the n input paths, and the n output paths define a MEAG. Circuitry is included to judge every different combination of one control path and one input path. The output paths are configured to pass input data received on the input paths and operated on as per control data received on the control paths.

Various optional and preferable features of the above embodiment include that m is equal three, and the control paths include increment, decrement, and bypass request paths. A preferable feature of this embodiment is an increment control next path configured to forward an increment signal in response to a wrap-around condition, a bypass next control path configured to forward a bypass signal in the absence of a wrap-around condition, and a decrement control next path configured to forward a decrement signal in response to a wrap-around condition.

Preferably, the control paths include increment and decrement paths. A preferable feature of this embodiment is an increment control next path configured to forward an increment signal in response to a wrap-around condition and a decrement control next path configured to forward a decrement signal in response to a wrap-around condition. Preferable features of this embodiment include two control paths, or a bypass next control path configured to forward a bypass signal in the absence of a wrap-around condition.

Preferably, the incrementor/decrementor of the above embodiment has four rails. Other preferable features of the above embodiment include a bank of m×n logical elements, each of which receives a different combination of one control path and one input path. In this embodiment, a preferable feature is m common connections of output of the logical elements consistent with the corresponding output values. The common connections may be inputs to a common logic element with one-of-three hysteresis functionality, wire ties, or an OR gates.

Preferably, one of the m control paths has fast functionality with the remaining m−1 paths having standard functionality. In this embodiment, each element in a first bank of (m−1)×n logical elements receives a different combination of one of the n input paths and one of the remaining m−1 control paths. A second bank of logical elements each receive inputs corresponding to a common condition from m−1 elements of the first bank and from one of the control paths. Preferably, the second bank of n logical elements transition in response to signals from one of the m−1 of the first logical elements, or inputs from one of the control paths together with input data.

According to another preferred embodiment of the invention, a multi-stage incrementor/decrementor is provided. This embodiment features at least one incrementor/decrementor cell aligned along at least one control data path. The cell includes m control paths, n input paths, and n output paths, and m control next paths where m and n are positive integers with n greater than two. Each of the m control paths, the n input paths, the n output paths, and the m control next paths define a MEAG. Circuitry judges every different combination of one control path and one input path. The control next paths are configured to pass wrap-around information. The output paths are configured to pass input data received on the input paths and operated on as per control data received on the control paths.

Other preferable features of the above embodiment include three control paths, including an increment control next path configured to forward an increment signal in response to a wrap-around condition, a bypass next control path configured to forward a bypass signal in the absence of a wrap-around condition, and a decrement control next path configured to forward a decrement signal in response to a wrap-around condition. The control paths preferably include an increment control next path configured to forward an increment signal in response to a wrap-around condition, and a decrement control next path configured to forward a decrement signal in response to a wrap-around condition, and a bypass next control path configured to forward a bypass signal in the absence of a wrap-around condition.

Preferably, the incrementor/decrementor cells of the above embodiment have four rails. Other preferable features of a cell in the above embodiment include a bank of m×n logical elements, each of which receives a different combination of one control path and one input path. A preferable feature is m common connections of output of the logical elements consistent with the corresponding output values. The common connections may be inputs to a common logic element with one-of-three hysteresis functionality, wire ties, or an OR gates.

Preferably, the incrementor/decrementor cells in the above embodiment have one of the m control paths with fast functionality and the remaining m−1 paths having standard functionality. In this embodiment, each element in a first bank of (m−1)×n logical elements receives a different combination of one of the n input paths and one of the remaining m−1 control paths. A second bank of logical elements each receive inputs corresponding to a common condition from m−1 elements of the first bank and from one of the control paths. Preferably, the second bank of n logical elements transition in response to signals from one of the m−1 of the first logical elements, or inputs from one of the control paths together with input data.

According to yet another preferred embodiment of the invention, a multi-stage incrementor/decrementor is provided. This embodiment features a first incrementor/decrementor cell, which can calculate a least significant MEAG. The first cell includes m−1 control paths, n input paths, n output paths, and m control next paths, where m and n are positive integers with m greater than one and n greater than two. Each of the m−1 control paths, the n input paths, and the n output paths define a MEAG. First circuitry judges every different combination of one control path and one input path. The output paths are configured to pass input data received on the input paths and operated on as per control data received on the control paths, and the control next paths are configured to pass wrap-around information. At least one additional cell, which can calculate an intermediary MEAG, includes m control paths, n input paths, and n output paths. Each of the m control paths, the n input paths, and the n output paths also define a MEAG. Second circuitry judges every different combination of one control path and one input path. The output paths are configured to pass input data received on the input paths and operated on as per control data received on the control paths, and the control next paths are configured to pass wrap-around information. Finally, a last cell, capable of calculating a most significant MEAG, includes m control paths, n input paths, and n output paths. Each of the m control paths, the n input paths, and the n output paths also define a MEAG. Third circuitry judges every different combination of one control path and one input path. The output paths are configured to pass input data received on the input paths and operated on as per control data received on the control paths, and the control next paths are configured to pass wrap-around information. The first and additional cells are capable of forwarding borrow and carry signals to adjacent downstream cells, and the additional and last cells are capable of receiving borrow and carry signals from adjacent upstream cells.

Other preferable features of the above embodiment include three control paths, including an increment control next path configured to forward an increment signal in response to a wrap-around condition, a bypass next control path configured to forward a bypass signal in the absence of a wrap-around condition, and a decrement control next path configured to forward a decrement signal in response to a wrap-around condition. The control paths preferably include an increment control next path configured to forward an increment signal in response to a wrap-around condition, and a decrement control next path configured to forward a decrement signal in response to a wrap-around condition, and a bypass next control path configured to forward a bypass signal in the absence of a wrap-around condition.

Preferably, the incrementor/decrementor cells of the above embodiment have four rails. Other preferable features of the first circuitry in the above embodiment include (m−1)×n first logical elements, each of which receives a different combination of one of the m−1 control paths associated with the first cell and one of the n input paths. The second circuitry includes m×n second logical elements, each of which receives a different combination of one of the m control paths associated with the additional cell and one of the n input paths. And the third circuitry includes m×n third logical elements, each of which receives a different combination of one of the m control paths associated with the last cell and one of the n input paths. A preferable feature of the first cells is m−1 common connections of output of the first logical elements consistent with the corresponding output values. Also preferable are m common connections of outputs of the second logical elements consistent with the corresponding output values. Also preferable are m common connections of outputs of the third logical elements consistent with the corresponding output values. The common connections may be inputs to a common logic element with one-of-three hysteresis functionality, wire ties, or an OR gates.

Preferably, the incrementor/decrementor cells in the above embodiment have one of the m control paths with fast functionality and the remaining m−1 paths having standard functionality. In this embodiment, each element in a first bank of (m−1)×n logical elements receives a different combination of one of the n input paths and one of the remaining m−1 control paths. A second bank of logical elements each receive inputs corresponding to a common condition from m−1 elements of the first bank and from one of the control paths. Preferably, the second bank of n logical elements transition in response to signals from one of the m−1 of the first logical elements, or inputs from one of the control paths together with input data.

Also preferable is that one of the control paths of the first cell of this embodiment may have fast functionality and the remaining paths standard functionality. In this embodiment, each of (m−2)×n logical elements in a first bank receives a different combination of one the m−2 control paths and one of the n input path. A second bank of logical elements each receive inputs consistent with a common condition from m−2 elements of the first bank and from one of the control paths. Preferably, the second bank of n logical elements transition in response to inputs from m−2 of the first elements, or from one of the control paths together with input data.

According to still another preferred embodiment of the invention, a multi-stage incrementor/decrementor is provided. This embodiment features a first incrementor/decrementor cell, which can calculate a least significant MEAG. The first cell includes m−1 control paths, n input paths, n output paths, and m control next paths, where m and n are positive integers with m greater than one and n greater than two. Each of the m−1 control paths, the n input paths, and the n output paths define a MEAG. First circuitry judges every different combination of one control path and one input path. The output paths are configured to pass input data received on the input paths and operated on as per control data received on the control paths, and the control next paths are configured to pass wrap-around information. Also, a last cell, capable of calculating a most significant MEAG, includes m control paths, n input paths, and n output paths. Each of the m control paths, the n input paths, and the n output paths also define a MEAG. Second circuitry judges every different combination of one control path and one input path. The first and last cells are aligned along at least one control path, and the first cell is capable of forwarding borrow and carry signals to the last cell.

Other preferable features of the above embodiment include three control paths, including an increment control next path configured to forward an increment signal in response to a wrap-around condition, a bypass next control path configured to forward a bypass signal in the absence of a wrap-around condition, and a decrement control next path configured to forward a decrement signal in response to a wrap-around condition. The control paths preferably include an increment control next path configured to forward an increment signal in response to a wrap-around condition, and a decrement control next path configured to forward a decrement signal in response to a wrap-around condition, and a bypass next control path configured to forward a bypass signal in the absence of a wrap-around condition. Preferably, the incrementor/decrementor cells of the above embodiment have four rails.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 is a circuit schematic of a four-rail incrementor/decrementor preferably used as a most significant MEAG cell.

FIG. 2 is a circuit schematic of a standard four-rail incrementor/decrementor cell.

FIG. 3 is a waveform simulation of input combinations to and responses from the circuit of FIG. 2.

FIG. 4 is a circuit schematic of a four-rail incrementor/decrementor preferably used as a least significant MEAG cell.

FIG. 5 is a circuit schematic of an four-cell incrementor/decrementor using four-rail cells.

FIG. 6 is a circuit schematic of a four-rail incrementor/decrementor cell with as fast bypass capability.

FIG. 7 is a circuit schematic of a four-rail incrementor/decrementor cell with fast increment capability.

FIG. 8 is a circuit schematic of a four-rail incrementor/decrementor cell with fast decrement capability.

### DETAILED DESCRIPTION OF THE EXEMPLARY EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

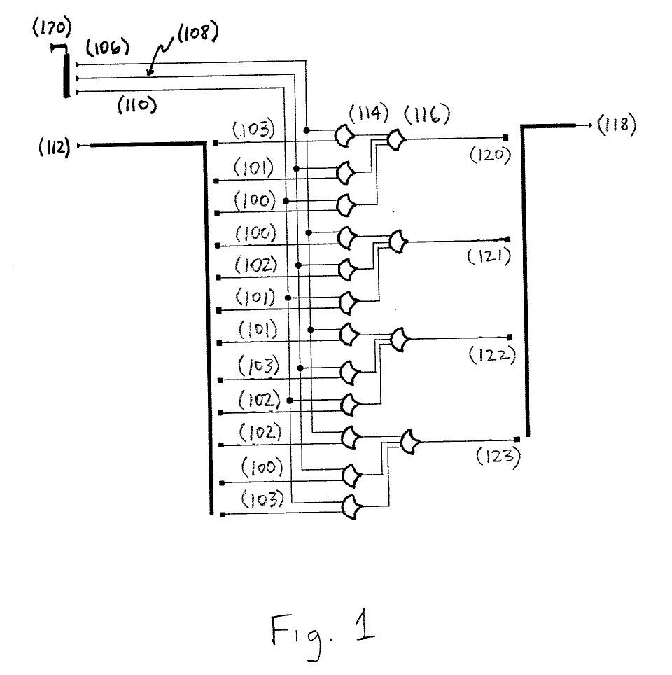

FIG. 1 is a schematic of the preferred embodiment of the invention. The illustrated circuit receives Input DATA representing values and separate Control DATA, and outputs Input DATA modified as consistent with the Control DATA.

An input bus 112 receives the data to be operated on. In the embodiment of FIG. 1, input bus 112 includes four DATA paths. Collectively, the four paths are called a MEAG (Mutually Exclusive Assertion Group) because only one may be ASSERTED at a time. Each group of three paths with common labels (100, 101, 102, and 103) in input bus 112 are electrically connected (the electrical connections to input bus 112 are not shown in FIG. 1). Each path of input bus 112 represents a unique DATA value ranging from ZERO to THREE. The presence of an ASSERT signal on any of paths 100, 101, 102, or 103 correspond to DATA ZERO, DATA ONE, DATA TWO, and DATA THREE, respectively. When all the paths NULL, i.e., when no paths are ASSERTED, the input is NULL. The presence of an ASSERT signal on any single path on input bus 112 constitutes DATA. Denoting ASSERTED by A and NULL by N, the values represented collectively by paths 100-103 are as follows:

TABLE 1

| | | | | | DATA |
|---|---|---|---|---|---|
| | Path 100 | Path 101 | Path 102 | Path 103 | value |
| MEAG Input | N | N | N | N | NULL |
| MEAG Input | A | N | N | N | DATA |
| | | | | | ZERO |
| MEAG Input | N | A | N | N | DATA |
| | | | | | ONE |
| MEAG Input | N | N | A | N | DATA |
| | | | | | TWO |
| MEAG Input | N | N | N | A | DATA |
| | | | | | THREE |

The Control signal bus 170 includes three Control paths and represents the operation to be performed on the Input DATA. The Control paths include Increment 106, Decrement 108, and Bypass 110. These paths also form a mutually exclusive assertion group (MEAG) in that only one may be ASSERTED at a time. The MEAG nature of the Control signal paths prevents the circuit from simultaneously receiving two or more different/inconsistent signals.

The presence of an ASSERT signal on Increment path 106 will cause the circuit of FIG. 1 to output one plus the input value (allowing for wrap-around for DATA THREE as discussed above). By way of non-limiting example, incrementing a DATA TWO input will result in a DATA THREE. Likewise, the presence of an ASSERT signal on Decrement path 108 will cause the circuit of FIG. 1 to output the value of the input signal minus one. By way of non-limiting example, decrementing DATA TWO will result in DATA ONE. The presence of an ASSERT signal on Bypass path 110 causes the Output DATA to be the same as the Input DATA. The presence of an ASSERT signal on a single path of Control bus 170 constitutes a Control Input (i.e., an ASSERT signal on a path provides DATA to the Control bus), and where no path is ASSERTED Control bus 170 is in a NULL state.

An Output bus 118 transmits the value on the Input bus 112 as may be altered consistent with the operation performed (e.g., Increment, Decrement, or Bypass). As with Input bus 112, Output bus 118 is implemented using four paths, which form a MEAG. The presence of an ASSERTED condition in any one of paths 120, 121, 122, and 123 corresponds to DATA ZERO, DATA ONE, DATA TWO, and DATA THREE, respectively.

Consistent with the above configuration, both Input DATA and Control DATA must be present before the Output transitions to DATA. That is, if either of the Input and Control MEAGs are NULL, then the Output MEAG will be NULL, and will not transition to DATA until both the Input and the Control MEAGs present a legal DATA value. The incrementor/decrementor commences processing when the Input and Control MEAGs present legal DATA values. The Input and Control MEAGs may then transition to NULL, which provides a buffer between waves of DATA.

The internal structure of the circuit illustrated by FIG. 1 is now described. The circuit is implemented preferably in a sum of min-terms fashion.

Each different combination of individual input and control paths input into a separate initial two-of-two threshold gate with hysteresis 114. The four data paths and three control paths thus define twelve (i.e., 3×4) combinations such that the circuit of FIG. 1 has a total of twelve initial threshold gates 114 in a first bank. The two-of-two threshold gates 114 must have both of their inputs ASSERTED before their outputs transition to ASSERTED. Similarly, both inputs must return to NULL before the gate output transitions to NULL. Due to the MEAG nature of Input bus 112 and Control bus 170, only one of the twelve gates 114 will receive two ASSERTED inputs; all other gates will receive at least one NULL input, such that only one gate 114 in the first bank will transition to DATA at a time. Therefore, each gate in the first bank correlates exactly with an allowable combination of Input DATA and Control DATA.

The second bank of gates in the circuit collects the outputs of the first bank of gates and delivers it to the Output bus 118. Of the twelve gates 114 in the first bank, the outputs of the three gates 114 that trigger the same output value feed into a single one-of-three threshold gate 116. By way of non-limiting example, the outputs of the gates that correspond to a DATA TWO value feed into the same one-of-three threshold gates including: Increment DATA ONE, Decrement DATA THREE, and Bypass DATA TWO. The output of the second bank of gates connects to Output bus 118.

Although the second bank includes one-of-three gates with hysteresis, the invention is not so limited. Other possibilities include wire-tie, OR gates, or combinations thereof.

The aforementioned gates and their operations are described in, for example, U.S. Pat. Nos. 5,640,105, 5,656,948, 5,664,211, 5,977,663, 6,020,754, and 6,043,674.

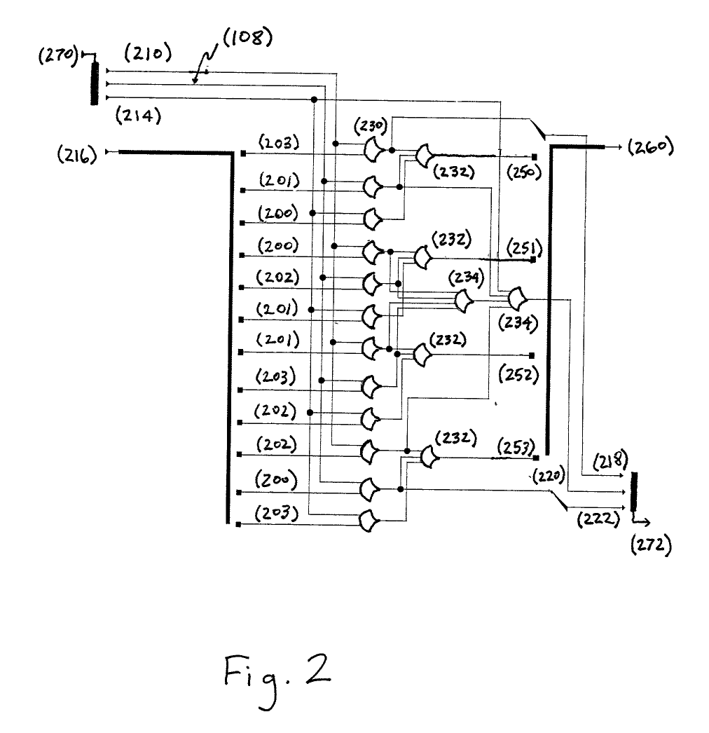

FIG. 2 illustrates a four-rail incrementor/decrementor circuit similar to that of FIG. 1 except for an additional subsystem, which indicates wrap-around or lack thereof. More specifically, Control Next bus 272 includes paths Next Increment 218, Next Bypass 220, and Next Decrement 222. Control Next bus 272 forms a MEAG in that only one path may be ASSERTED at a time. Next Increment path 218 is ASSERTED in response to a request to Increment DATA THREE. Similarly, Next Decrement path is ASSERTED in response to a request to Decrement DATA ZERO. All other cases of input combinations (i.e., all other cases of Input DATA and Control DATA) result in Next Bypass 220 being ASSERTED.

The additional subsystem noted above includes a third bank of gates 234 that collects information and feeds it to the Control Next bus 272. More specifically, Next Increment 218 connects with the output to the first bank gate 114 that transitions to ASSERTED in a response to Increment DATA THREE. This transition thus represents both DATA ZERO and the wrap-around condition. Similarly, Next Decrement 222 connects to the output to the first bank gate that transitions to ASSERTED in response to a request to decrement DATA ZERO. This path thus represents both DATA THREE and the associated wrap-around. Next Bypass 220 indicates that the input combination in the current incrementor/decrementor cell does not generate a carry or require a borrow. In particular, Next Bypass 220 connects to the output of a gate whose inputs connect to the Bypass control path and to each output of second bank gates not bypassed and not connected to Next Increment and Next Decrement. In particular, inputs to the gates feeding into Next Bypass 220 connect to the outputs from the first bank gates that activate upon the following combination of inputs: Increment DATA ZERO, Increment DATA ONE, Increment DATA TWO, Decrement DATA THREE, Decrement DATA TWO, and Decrement DATA THREE. As illustrated in FIG. 2, more that one gate may be necessary to collect together all required inputs to Next Bypass. FIG. 2 shows two one-of-four gates 234 with hysteresis used for this purpose, but the invention is not limited to this structure.

Similar to the operation of the circuit of FIG. 1, the presence of an ASSERT signal on any one of paths 200, 201, 202, and 203 correspond to DATA ZERO, DATA ONE, DATA TWO, or DATA THREE, respectively, and a single ASSERTED one of paths 250, 251, 252 and 253 correspond to DATA ZERO, DATA ONE, DATA TWO, or DATA THREE, respectively. Control bus 270 includes Increment 210, Decrement 212 and Bypass 214 paths.

Table 2 illustrates the terminal operation of the circuit of FIG. 2. Here, A represents ASSERTED and N represents NULL. The all NULL case does not represent any DATA value (shown in the first entry of Table 1) and acts as a wave of NULL interspersed between waves of DATA. Intermediate cases not shown in the table result in no change to the outputs due to hysteresis built into each gate.

TABLE 2

| Input | | | | | | | | OUTPUT PATHS | | | | | | |
|---|---|---|---|---|---|---|---|---|---|---|---|---|---|---|
| Combination | INPUT PATHS | | | | | | | | | | | Nxt. | Nxt. | Nxt. |
| ↓ | zero | one | two | three | Inc. | Dec. | Byp. | zero | one | two | three | Inc. | Dec. | Byp |
| Null | N | N | N | N | N | N | N | N | N | N | N | N | N | N |
| Null | | | | | | | | | | | | | | |
| Inc. | A | N | N | N | A | N | N | N | A | N | N | N | N | A |
| zero | | | | | | | | | | | | | | |
| Inc. | N | A | N | N | A | N | N | N | N | A | N | N | N | A |
| one | | | | | | | | | | | | | | |
| Inc. | N | N | A | N | A | N | N | N | N | N | A | N | N | A |
| two | | | | | | | | | | | | | | |
| Inc. | N | N | N | A | A | N | N | A | N | N | N | A | N | N |
| three | | | | | | | | | | | | | | |
| Dec. | A | N | N | N | N | A | N | N | N | N | A | N | A | N |
| zero | | | | | | | | | | | | | | |
| Dec. | N | A | N | N | N | A | N | A | N | N | N | N | N | A |
| one | | | | | | | | | | | | | | |
| Dec. | N | N | A | N | N | A | N | N | A | N | N | N | N | A |
| two | | | | | | | | | | | | | | |
| Dec. | N | N | N | A | N | A | N | N | N | A | N | N | N | A |
| three | | | | | | | | | | | | | | |
| Byp. | A | N | N | N | N | N | A | A | N | N | N | N | N | A |
| zero | | | | | | | | | | | | | | |
| Byp. | N | A | N | N | N | N | A | N | A | N | N | N | N | A |
| one | | | | | | | | | | | | | | |
| Byp. | N | N | A | N | N | N | A | N | N | A | N | N | N | A |
| two | | | | | | | | | | | | | | |
| Byp. | N | N | N | A | N | N | A | N | N | N | A | N | N | A |
| three | | | | | | | | | | | | | | |

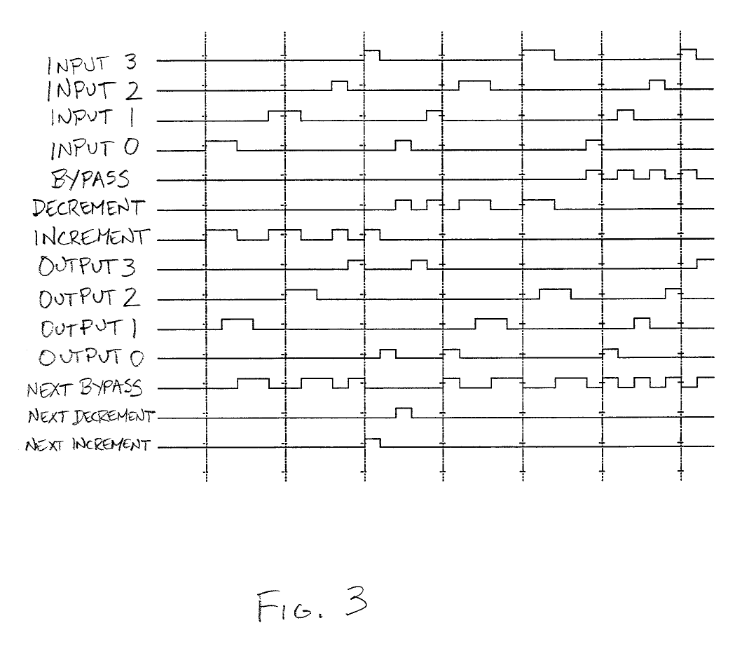

FIG. 3 illustrates simulation waveforms of the four-rail incrementor/decrementor cell of FIG. 2 when acted upon by the inputs listed in Table 2. The signal names of each waveform are listed to the left, and time flows from left to right. In FIG. 3, high level should be interpreted as ASSERTED and a low level should be interpreted as NULL (i.e., in a positive logic implementation). Initially all inputs and outputs are set to NULL. The FIG. 3 Input DATA is then sequentially applied in the order shown in Table 2, resulting in the corresponding Outputs indicated by the same table. A wave of NULL inputs (only the first of which is shown in Table 2) is interspersed between each wave of DATA. Then Increment and DATA ZERO are ASSERTED (DATA ZERO and Increment are high). After some technology dependent time delay, the Output transitions to DATA ONE (DATA ONE is high in the Output bus), and the Next Bypass signal is ASSERTED (indicating that no carry out is present). Once DATA has been received on the Outputs, a wave of NULL (not shown in Table 2) is once again applied to the inputs and propagates through the circuit before the next data is applied. In this case, the next input applies is DATA ONE, which is incremented. The cycle repeats until all of the inputs indicated in Table 2 are applied.

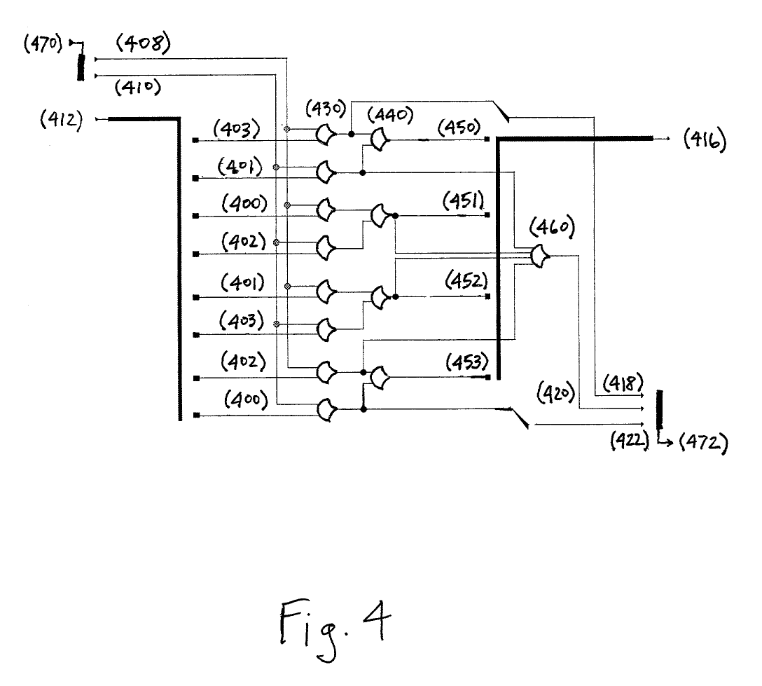

FIG. 4 illustrates an incrementor/decrementor cell that is preferably used as part of a larger cascaded incrementor/decrementor to compute the least significant MEAG. A bypass path for this implementation is not required because incrementing of decrementing a value by one will always alter the least significant MEAG. Because the bypass function is not needed, all of the circuitry used to implement this function in the standard four-rail cell is removed. Otherwise, the cell's structure and behavior is analogous to the circuit of FIG. 1. The presence of an ASSERT signal on any one of paths 400, 401, 402, and 403 in Input bus 412 correspond to DATA ZERO, DATA ONE, DATA TWO, and DATA THREE, respectively, and a single ASSERTED one of paths 450, 451, 452 and 453 in Output bus 416 correspond to DATA ZERO, DATA ONE, DATA TWO, and DATA THREE, respectively, Control bus 470 includes Increment 408 and Decrement 410, and Control Next bus 472 included Next 418, Next Bypass 420, and Next Decrement 422 paths.

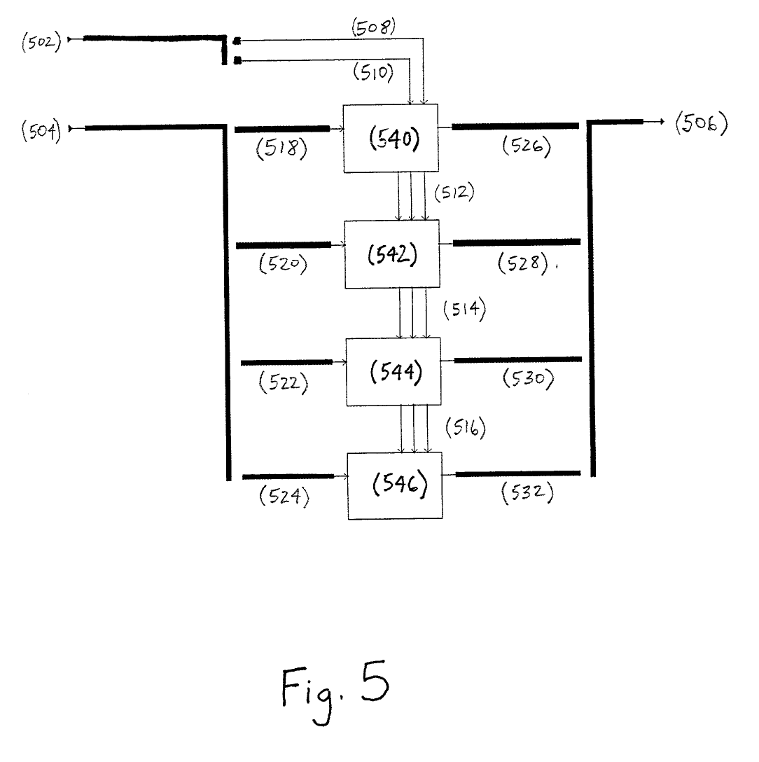

The circuits illustrated in FIGS. 1, 2 and 4 may be used as stand-alone circuits or may be implemented as part of larger incrementor/decrementors that can handle a wider range of numbers. FIG. 5 below illustrates in detail how individual incrementor/decrementor cells can be arranged to build circuits able to handle larger numbers. In particular, cascades such as that illustrated in FIG. 5 will preferably use one least significant MEAG cell (e.g., the circuit of FIG. 4), one most significant MEAG cell (e.g., the circuit of FIG. 1), and several intermediary MEAG cells (e.g., the circuit of FIG. 2). Alternately, any combination of intermediary MEAG cells may substitute for least or most significant MEAG cells by not using the unnecessary inputs or outputs.

FIG. 5 is an example incrementor/decrementor built from four cascaded incrementor/decrementor cells, which can increment or decrement 256 different values (0 through 255). The circuit includes a first cell 540 as illustrated in FIG. 4 to calculate the least significant MEAG. The Control bus 502 of the entire cascaded circuit includes Increment 508 and Decrement 510 paths of first cell 540 The Control Next bus of this cell 512 feeds into the Control bus of second cell 542 (e.g., the circuit illustrated in FIG. 2), which handles the lower intermediary MEAG. The Control Next bus of second cell 542 feeds into Control bus 514 of third cell 544 (e.g., the circuit illustrated in FIG. 2), which calculates the upper intermediary MEAG. The Control Next bus 516 of this cell is in turn connected to the Control bus of a most significant MEAG fourth cell 546 (e.g., the circuit illustrated in FIG. 1). The Input bus 504 for the cascaded circuit includes the Input busses 518, 520, 522, 546 from the constituent cells. Likewise, the Output bus 506 for the cascaded circuit includes the Output busses 526, 528, 530, 532 from the constituent cells.

With regard to FIG. 5, because the circuit uses four-rail logic, the terms “least significant”, “most significant” and “intermediary” MEAGs are used. The cells are connected together via the Control DATA path; that is, the Control Next bus of a cell are typically connected to the Control bus of the next adjacent downstream cell. Likewise, the Control DATA path includes connections from the Control bus of each cell which is not associated with the least significant MEAG to the Control Next bus of the next adjacent upstream cell. The term downstream connotes increasing significance in the associated MEAGs. The totality 504 of the Input busses 518, 520, 522, 546 form the Input bus for the cascaded incrementor/decrementor of FIG. 5. The value represented by the entire bus is computed by multiplying the value of least significant MEAG by one, the next intermediary MEAG by four, the next intermediary MEAG by sixteen, and continuing in this way by multiplying the next MEAG value by the next power of four. In other words, the value of the entire DATA bus is the sum of 4ⁿ times the the n-th MEAG value, starting with n=0. The computation is analogous to base-four arithmetic where each MEAG represents a digit. In this manner, the circuit of FIG. 5 is capable of representing values from 0 to 255, inclusive.

By way of non-limiting example, suppose least significant Input MEAG 518 receives DATA THREE, lower intermediary MEAG 520 receives DATA TWO, upper intermediary MEAG 522 receives DATA ZERO, and most significant MEAG 524 receives DATA ONE. In this case, the Input to the entire cascade circuit through Input bus 504 corresponds to the value 3×4⁰+2×4¹+0×4²+1×4³=75. That is, 75=(NNAN)(NNNA(NANN)(ANNN), where each MEAG corresponds to a separate set of parentheses and is listed in descending significance, “A” corresponds to ASSERTED, and “N” corresponds to NULL. If Increment 508 receives an ASSERT signal while Input bus 502 holds this value, then Output bus 506 will represent (NNAN)(NNNA)(ANNN)(NNNA)=76=75 +1 as follows: least significant Input MEAG 518 presents DATA ZERO, lower intermediary MEAG 520 presents DATA THREE, upper intermediary MEAG 522 presents DATA ZERO, and most significant MEAG 524 presents DATA ONE. In this case, first cell 540 sends an Increment signal via Control Next bus 512 to second cell 514 because DATA THREE at Input MEAG 518 wrapped-around to DATA ZERO at output MEAG 526, consistent with Increment 508 receiving an ASSERT signal.

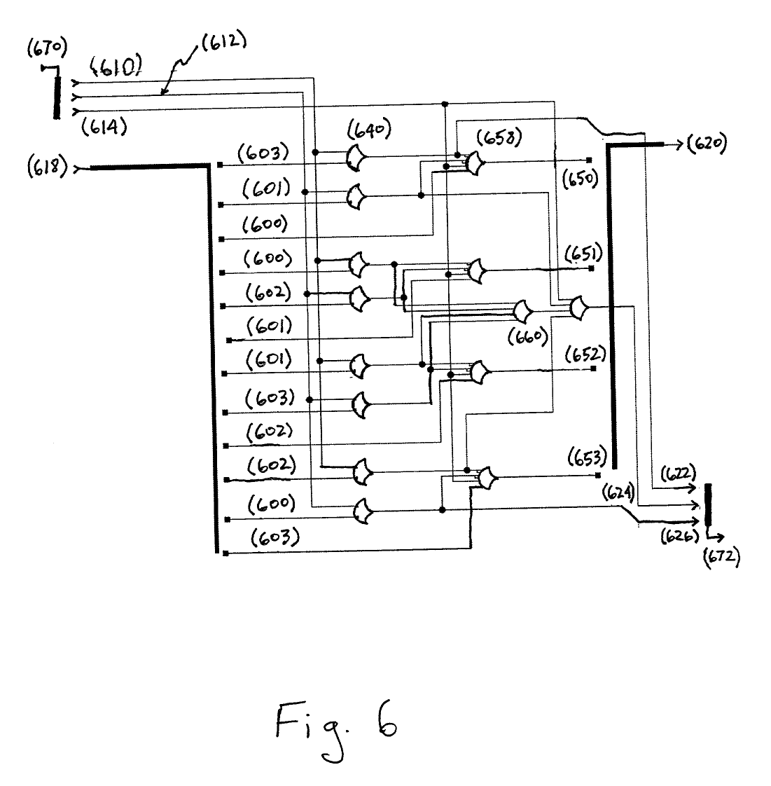

FIG. 6 illustrates a four-rail cell with fast bypass capability. In this case, the speed of the output signals is improved in the Bypass case relative to Increment and Decrement. This can be an advantageous in asynchronous systems. Because no overall time reference is used (i.e., clock), each operation may be designed to run at different speeds. The construction of the circuit of FIG. 6 is similar to that of the circuit of FIG. 2, but with the following modifications. As in the standard cell, there are initial two-of-two gates 640 with hysteresis for the Increment and Decrement operations. A second bank of four-input threshold gates 658 having thresholds of two with two input paths of weight two and two input paths of weight one collect the outputs of the eight initial gates and deliver them to Output bus 620. More particularly, each output of the initial Increment or Decrement gates 640 outputs into a path of weight two in the second bank gate whose output connects to the appropriately valued path on the Output bus. For example, the output of the initial gate that receives Increment and DATA TWO paths feeds into an input of weight two in the second bank gate whose output connects to the DATA THREE path of the Output bus. One difference between the incrementor/decrementor of FIG. 6 and the standard incrementor/decrementor of FIG. 2 is that here the bypass path and DATA Input paths feed directly into inputs of weight one in the appropriate second bank gate. For example, the combination input signals of DATA THREE and Bypass feed directly into inputs of weight one in the gate in the second bank whose output connects to the DATA THREE path of the Output bus (i.e., the same gate as in the above example in this paragraph). Thus, the first bank gates are circumvented in the case of a Bypass control signal. In addition to first and second bank gates as discussed above, a third bank of gates 660 collect information and feed it to the Control Next bus 622, 624, and 626 just as in the circuit of FIG. 2.

The presence of an ASSERT signal on any one of paths 600, 601, 602, and to 603 in Input bus 618 correspond to DATA ZERO, DATA ONE, DATA TWO, and DATA THREE, respectively, and a single ASSERTED one of paths 650, 651, 652 and 653 in Output bus 620 correspond to DATA ZERO, DATA ONE, DATA TWO, and DATA THREE, respectively. Control bus 670 includes Increment 610, Decrement 612, and Bypass 614, and Control Next bus 672 includes Next Increment 622, Next Bypass 624, and Next Decrement 626 paths.

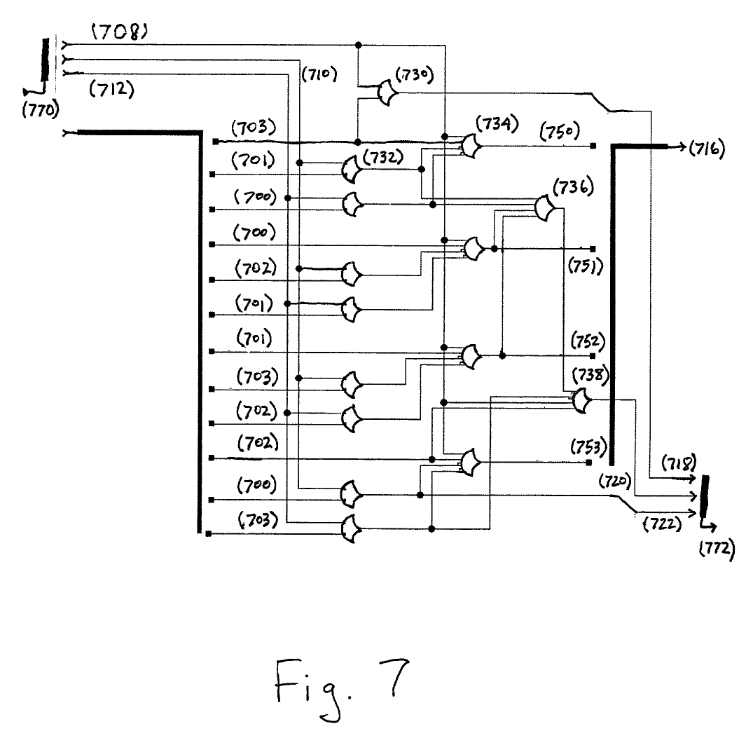

FIG. 7 illustrates an incrementor/decrementor circuit with fast increment capability. The advantages of this design are similar to the advantages of the design of the circuit of FIG. 6.

The construction of the circuit of FIG. 7 is similar to that of the circuit of FIG. 2, but with the following modifications. As in the standard cell, there are initial two-of-two gates 732 with hysteresis for the Decrement and Bypass operations. A second bank of four-input threshold gates 734 having thresholds of two with two input paths of weight two and two input paths of weight one collect the outputs of the eight initial gates and delivers them to the Output bus. More particularly, each output of the initial Decrement or Bypass gates is fed into a path of weight two in the second bank gate whose output connects to the appropriately valued path on the Output bus. For example, the output of the initial gate that receives Decrement and DATA THREE signals feeds into an input of weight two in the second bank gate whose output connects to the path of value 2 in the Output bus. A difference between the incrementor/decrementor of FIG. 7 and the standard incrementor/decrementor of FIG. 2 is that here the Increment path and DATA Input paths feed directly into inputs of weight one in the appropriate second bank gate. For example, the combination of DATA ONE and Increment feed directly into inputs of weight one in the second bank gate whose output connects to the DATA TWO path of the Output bus (i.e., the same gate as in the above example in this paragraph). Thus, the first bank of gates 732 are circumvented in the case of an increment control signal. In addition to first and second bank of gates as discussed above, a third bank of gates collect information and feeds it to the Control Next bus similar to that of the circuit of FIG. 2. Finally, there is a dedicated two-of-two gate 730 whose input connects to the Increment control 708 and DATA THREE path 703 and whose output connects to the Next Increment path 718.

The presence of an ASSERT signal on any one of paths 700, 701, 702, and 703 in Input bus 760 correspond to DATA ZERO, DATA ONE, DATA TWO, and DATA THREE, respectively, and a single ASSERTED one of paths 750, 751, 752 and 753 in Output bus 716 correspond to DATA ZERO, DATA ONE, DATA TWO, and DATA THREE, respectively. Control bus includes Increment 708, Decrement 710, and Bypass 712, and Control Next bus includes Next Increment 718, Next Bypass 720, and Next Decrement 722 paths.

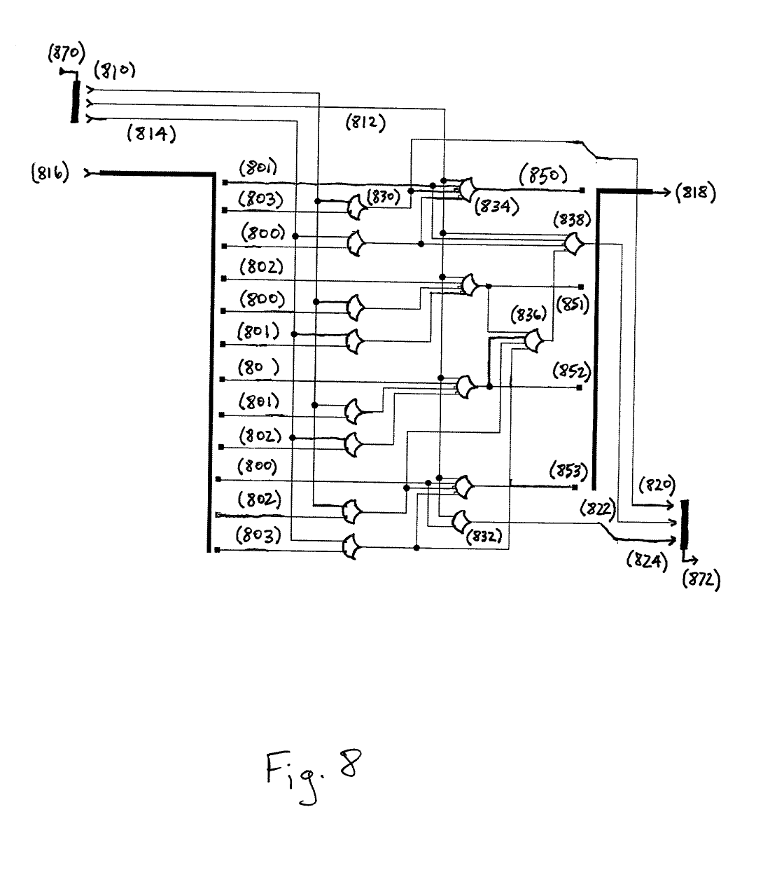

FIG. 8 illustrates an incrementor/decrementor circuit with fast decrement capability. The advantages of this design are similar to the advantages of the design of the circuit of FIG. 6. The construction of the circuit of FIG. 8 is similar to that of the circuit of FIG. 2, but with the following modifications. As in the standard cell, there are initial two-of-two gates 830 with hysteresis for the Increment and Bypass operations. A second bank of four-input threshold gates 834 having thresholds of two with two input paths of weight two and two input paths of weight one collect the outputs of the eight initial gates and delivers them to the Output bus. More particularly, each output of the initial Increment or Bypass gates is fed into an input of weight two in the second bank gate whose output connects to the appropriate data path on the Output bus. For example, the output of the initial gate that receives Increment and DATA ZERO signals feeds into an input of weight two in the second bank gate whose output connects to the DATA ONE path of the Output bus. One difference between the incrementor/decrementor of FIG. 8 and the standard incrementor/decrementor of FIG. 2 is that here the Decrement path and Input DATA paths feed directly into inputs of weight one in the appropriate second bank gate. For example, the combination input signals of DATA TWO and Decrement feed directly into inputs of weight one are second bank gate whose output connects to the DATA ONE path of the Output bus (i.e., the same gate as in the above example in this paragraph). Thus, the first bank gates 830 are circumvented in the case of a Decrement control signal. In addition to first and second bank gates as discussed above, a third bank of gates collect information and feeds it to the Control Next bus 820, 822, and 824 similar to that of the circuit of FIG. 2. Finally, there is a dedicated two-of-two gate 832 whose input connects to the Decrement control 812 and DATA ZERO path 800 and whose output connects to the Next Decrement path 824.

The presence of an ASSERT signal on any one of paths 800, 801, 802, and 803 in Input bus 816 correspond to DATA ZERO, DATA ONE, DATA TWO, and DATA THREE, respectively, and a single ASSERTED one of paths 850, 851, 852 and 853 in Output bus 818 correspond to DATA ZERO, DATA ONE, DATA TWO, and DATA THREE, respectively. Control bus included Increment 810, decrement 812, and Bypass 814, and Control Next bus includes Next Increment 820, Next Bypass 822, and Next Decrement 824 paths.

It would be possible to utilize the optimization circuits illustrated in FIGS. 6, 7, and 8 on different MEAGs of a larger incrementor/decrementor. This would have the effect of allowing a particular case to run faster than all other cases (e.g., incrementing from the value 127 to 128), and would allow a system to run faster for common or important events at the expense of rare or unimportant events. Optimizations for the most significant and least significant MEAGs (i.e., as illustrated in FIGS. 1 and 4, respectively) could be made for each of these circuits as well. Other variations could be generated using a tool such as NCL_SHELL

It is possible to optimize the circuitry disclosed herein by way of software or other methodology. One skilled in the art may first design circuitry as per the above disclosure and then optimize so as to yield more efficient versions which perform essentially the same function. Moreover, such optimized versions may have structure different from the pre-optimized designs. This disclosure contemplates such optimization of the disclosed embodiments.

The above description is generally directed to positive logic, however the invention is not so limited. Designs using negative logic also fall into the scope and spirit of the invention.

An advantage of the four-rail encoded incrementor/decrementor over a dual rail version is that in four-rail, two binary digits worth of information is transmitted with the switching of a single path. In contrast, a dual-rail implementation requires two paths to switch in order to transmit the same amount of information. Four-rail thus consumes approximately half (50%) of the power of a dual-rail implementation.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. An incrementor/decrementor comprising:
m control paths defining a MEAG, where m is a positive integer;
n input paths defining a MEAG, where n is a positive integer greater than two;
circuitry configured to judge every different combination of each one of said m control paths with each one of said n input paths; and
n output paths defining a MEAG configured to pass input data received on said input paths operated on as per control data received at said control paths.

2. the incrementor/decrementor of claim 1, wherein m=3 and said control paths include increment, decrement, and bypass request paths.

3. The incrementor/decrementor of claim 1, wherein said control paths include increment and decrement request paths.

4. The incrementor/decrementor of claim 2 further comprising an increment control next path configured to forward an increment signal in response to a wrap-around condition, a bypass next control path configured to forward a bypass signal in the absence of a wrap-around condition, and a decrement control next path configured to forward a decrement signal in response to a wrap-around condition.

5. The incrementor/decrementor of claim 3 further comprising an increment control path configured to forward an increment signal in response to a wrap-around condition and a decrement control next path configured to forward a decrement signal in response to a wrap-around condition.

6. The incrementor/decrementor of claim 5, wherein m=2.

7. The incrementor/decrementor of claim 5 further comprising a bypass next control path configured to forward a bypass signal in the absence of a wrap-around condition.

8. The incrementor/decrementor of claim 1, wherein n=4.

9. The incrementor/decrementor of claim 1, wherein said circuitry comprises a bank of m×n first logical elements, each of said first logical elements receiving a different combination of one of said n input paths and one of said m control paths.

10. The incrementor/decrementor of claim 9, further comprising m common connections of outputs of said first logical elements consistent with corresponding output values.

11. The incrementor/decrementor of claim 10, wherein each of said common connections is one of a wire tie, inputs to a common logic element with one-of-three hysteresis functionality, and an OR gate.

12. The incrementor/decrementor of claim 1 further comprising:
one of said m control paths having fast path functionality, and the remaining m−1 control paths having standard functionality;
a first bank of (m−1)×n logical elements, each of which receive a different combination of one of said n inputs paths and one of said remaining m−1 control paths; and
a second bank of n logical elements, each configured to output to receive inputs from m−1 of said first logical elements, and from said one of said control paths, said inputs corresponding to a common condition.

13. The incrementor/decrementor of claim 12, wherein said second bank of n logical elements transition in response to signals from one of:
one of said inputs from m−1 of said logical elements; and
said one of said control paths together with a data input.

14. A multi-stage incrementor/decrementor comprising:
at least one incrementor/decrementor cell aligned along at least one control data path, each of said at least one incrementor/decrementor cell comprising:
(a) m control paths defining a MEAG, where m is a positive integer;
(b) n input paths defining a MEAG, where n is a positive integer greater than two;
(c) circuitry configured to judge every combination of each one of said m control paths with each one of said n input paths;
(d) n output paths defining a MEAG configured to pass input data received on said input paths operated on as per control data received at said control paths
(e) m control next paths defining a MEAG configured to pass wrap-around information,
said control next paths of an upstream one of said at least one incrementor/decrementor cells being connected to said control paths of an adjacent downstream incrementor/decrementor cell.

15. The multi-stage incrementor/decrementor of claim 14, wherein m=3, and:
(a) said control paths include and increment control path configured to receive an increment signal, a bypass control path configured to receive a bypass signal, and a decrement control path configured to receive a decrement signal; and
(b) said control next paths include an increment control next path configured to forward an increment signal in response to a carry condition, a bypass control next pass configured to carry a bypass request in the absence of carry and borrow conditions, and a decrement control next path configured to forward a decrement signal in response to a borrow condition.

16. The multi-stage incrementor/decrementor of claim 14, wherein n=4.

17. The multi-stage incrementor/decrementor of claim 14, wherein said circuitry comprises a bank of m×n first logical elements, each of said first logical elements receiving a different combination of one of said n input paths and one of said m control paths.

18. The multi-stage incrementor/decrementor of claim 17, further comprising m common connections of outputs of said first logical elements consistent with corresponding output values.

19. The incrementor/decrementor of claim 18, wherein each of said common connections is one of a wire tie, inputs to a common logic element with one-of-three hysteresis functionality, and an OR gate.

20. The multi-stage incrementor/decrementor of claim 14, wherein said at least one incrementor/decrementor cell further comprises:
one of said m control paths having fast path functionality, and the remaining m−1 control paths having standard functionality;
a first bank of (m−1)×n logical elements, each of which receives a different combination of one of said n input paths and one of said remaining m−1 control paths; and
a second bank of n logical elements, each configured to output to receive inputs from m−1 of said first logical elements, and from said one of said control paths, said inputs corresponding to a common condition.

21. The multi-stage incrementor/decrementor of claim 20, wherein said second bank of n logical elements transition in response to signals from one of:
one of said inputs from m−1 of said logical elements; and
said one of said control paths together with a data input.

22. A multi-stage incrementor/decrementor comprising:
a first cell capable of calculating a least significant MEAG comprising:
(a) m−1 control paths defining a MEAG, where m is a positive integer greater than one;
(b) n input paths defining a MEAG, where n is a positive integer greater than two;
(c) first circuitry configured to judge every combination of each one of said m−1 control paths with each one of said n input paths;
(d) n output paths defining a MEAG configured to pass input data received on said input paths operated on as per control data received at said control paths;
(e) m control next paths defining a MEAG configured to pass wrap-around information;
at least one next cell capable of calculating an intermediary MEAG comprising;
(f) m control paths defining a MEAG
(g) n input paths defining a MEAG;
(h) second circuitry configured to judge every combination of each one of said m control paths with each one of said n input paths;
(i) n output paths defining a MEAG configured to pass input data received on said input paths operated on as per control data received at said control paths;
(j) m control next paths defining a MEAG configured to pass wrap-around information;
a last cell capable of calculating a most significant MEAG comprising:
(k) m control paths defining a MEAG;
(l) n input paths defining a MEAG;
(m) third circuitry configured to judge every combination of each one of said m control paths with each one of said n input paths;
(n) n output paths defining a MEAG configured to pass input data received on said input paths operated on as per control data received at said control paths;
said first, at least one next, and last cells aligned along at least one control path, wherein:
each of said first and said at least one next cell is capable of forwarding borrow and carry signals to the adjacent downstream cell, and each of said at least one next and last cell is capable of receiving borrow and carry signals from the adjacent upstream cell.

23. The multi-stage incrementor/decrementor of claim 22, wherein m=3, and:
(a) said control paths include an increment control path configured to receive an increment signal and a decrement control path configured to receive a decrement signal; and
(b) said control next paths include an increment control next path configured to forward an increment signal in response to a carry condition, a bypass control next pass configured to carry a bypass request in the absence of borrow and carry conditions, and a decrement control next path configured to forward a decrement signal in response to a borrow condition.

24. The multi-stage incrementor/decrementor of claim 22, wherein n=4.

25. The multi-stage incrementor/decrementor of claim 22, wherein:
said first circuitry comprises (m−1)×n first logical elements, each of said first logical elements receiving a different combination of one of said n input paths and one of said m−1 control paths associated with said first cell;
said second circuitry comprises m×n second logical elements, each of said second logical elements receiving a different combination of one of said n input paths and one of said m control paths associated with said at least one next cell; and
said third circuitry comprises m×n third logical elements, each of said third logical elements receiving a different combination of one of said n input paths and one of said m control paths associated with said last cell.

26. The multi-stage incrementor/decrementor of claim 25, further comprising:
m−1 common connections of outputs of said first logical elements consistent with corresponding output values;
m common connections of outputs of said second logical elements consistent with corresponding output values; and
and m connections of outputs of said third logical elements consistent with corresponding output values.

27. The incrementor/decrementor of claim 26, wherein each of said common connections is one of a wire tie, inputs to a common logic element with one-of-three hysteresis functionality, and an OR gate.

28. The multi-stage incrementor/decrementor of claim 22, wherein said at least one of said first, at least one next and last incrementor/decrementor cells further comprises:
one of said am control paths having fast path functionality, and the remaining m−1 control paths having standard functionality;
a first bank of (m−1)×n logical elements, each of which receives a different combination of one of said n input paths and one of said remaining m−1 control paths; and
a second bank of n logical elements, each configured to output to receive inputs from m−1 of said first logical elements, and from said one of said control paths, said inputs corresponding to a common condition.

29. The multi-stage incrementor/decrementor of claim 28, wherein said second bank on n logical elements transition in response to signals from one of:
one of said inputs from m−1 of said logical elements; and
said one of said control paths together with a data input.

30. The multi-stage incrementor/decrementor of claim 22, wherein said first incrementor/decrementor cell further comprises:
one of said m−1 control paths having fast path functionality, and remaining m−2 control paths having standard functionality;
a first bank of (m−2)×n logical elements, each of which receives a different combination of one of said n input paths and one of said remaining m−2 control paths; and
a second bank of n logical elements, each configured to output to receive inputs form m−2 of said first logical elements, and from said one of said control paths, said inputs corresponding to a common condition.

31. The multi-stage incrementor/decrementor of claim 30, wherein said second bank of n logical elements transition in response to signals from one of:
one of said inputs from m−2 of said logical elements; and
said one of said control paths together with a data input.

32. A multi-stage incrementor/decrementor comprising:
a first cell capable of calculating a least significant MEAG comprising:
(a) M−1 control paths defining a MEAG, where m is a positive integer greater than one;
(b) n input paths defining a MEAG, where n is a positive integer greater than two;
(c) first circuitry configured to judge every combination of each one of said m−1 control paths with each one of said n input paths;
(d) n output paths defining a MEAG configured to pass input data received on said input paths operated on as per control data received at said control paths;
(e) m control next paths defining a MEAG configured to pass wrap-around information;
a last cell capable of calculating a most significant MEAG comprising:
(f) m control paths defining a MEAG;
(g) n input paths defining a MEAG;
(h) second circuitry configured to judge every combination of each one of said m control paths with each one of said n input paths;
(i) n output paths defining a MEAG configured to pass input data received on said input paths operated on as per control data received at said control paths;
said first and last cells aligned along at least one control path, wherein:
said first cell is capable of forwarding borrow and carry signals downstream to said last cell.

33. The multi-stage incrementor/decrementor of claim 32, wherein m=3, and:
(a) said control paths include an increment control path configured to receive an increment signal and a decrement control path configured to receive a decrement signal; and
(b) said control next paths include an increment control next path configured an increment signal in response to a carry condition, a bypass control next pass configured to carry a bypass request in the absence of borrow and carry conditions, and a decrement control next path configured to forward a decrement signal in response to a borrow condition.

34. The multi-stage incrementor/decrementor of claim 32, wherein n=4.
